(19) United States
(12) Patent Application Publication
(10) Pub. No.: US 2023/0377324 A1
(43) Pub. Date: Nov. 23, 2023

(54) MULTI-DOMAIN GENERATIVE ADVERSARIAL NETWORKS FOR SYNTHETIC DATA GENERATION

(71) Applicant: NVIDIA Corporation, Santa Clara, CA (US)

(72) Inventors: Seung Wook KIM, Toronto (CA); Karsten Julian KREIS, Vancouver (CA); Daiqing LI, Oakville (CA); Sanja FIDLER, Toronto (CA); Antonio TORRALBA BARRIUSO, Somerville, MA (US)

(73) Assignee: NVIDIA Corporation, Santa Clara, CA (US)

(21) Appl. No.: 18/319,689

(22) Filed: May 18, 2023

Related U.S. Application Data
(60) Provisional application No. 63/344,011, filed on May 19, 2022.

(51) Int. Cl. G06V 10/82; G06V 10/77

(52) U.S. Cl. CPC G06V 10/82; G06V 10/7715

(57) ABSTRACT

In various examples, systems and methods are disclosed relating to multi-domain generative adversarial networks with learned warp fields. Input data can be generated according to a noise function and provided as input to a generative machine-learning model. The generative machine-learning model can determine a plurality of output images each corresponding to one of a respective plurality of image domains. The generative machine-learning model can include at least one layer to generate a plurality of morph maps each corresponding to one of the respective plurality of image domains. The output images can be presented using a display device.

### CROSS-REFERENCES TO RELATED PATENT APPLICATIONS

This application claims priority from Provisional Application U.S. Application 63/344,011, filed May 19, 2022, incorporated herein by reference in its entirety.

### BACKGROUND

Generative machine-learning models, such as generative adversarial networks (GANs) are a class of deep learning models used for generating data samples, such as images, that resemble a given dataset. Although different domains may share similar semantics and characteristics, conventional generative machine-learning models are unable to generate aligned data samples across different domains simultaneously.

### SUMMARY

Embodiments of the present disclosure relate to systems and methods for multi-domain generative adversarial networks with learned warp fields. The present disclosure provides generative machine-learning models that can simultaneously generate aligned image samples from multiple related domains. The generative machine-learning models can be updated/trained to learn the shared features across multiple domains and a per-domain morph layer to morph shared features according to each domain. Conventional generative machine-learning models fail to simultaneously model images with highly varying geometries, such as images of human faces, painted and artistic faces, as well as multiple different animal faces.

The techniques described herein leverage the fact that a variety of object classes may share common attributes, despite certain geometric differences. In addition to simultaneously generating aligned image samples from multiple related domains, the generative machine-learning models described herein produce aligned samples that can be used for applications such as segmentation transfer and cross-domain image editing, as well as training in low-data regimes. The generative machine-learning models described herein can be utilized for image-to-image translation tasks, and greatly surpass the performance of conventional approaches in cases where the geometric differences between domains are large.

At least one aspect relates to a processor. The processor can include one or more circuits. The one or more circuits can generate input data according to a noise function. The one or more circuits can determine, using a generative machine-learning model and based at least on the input data, a plurality of output images each corresponding to one of a respective plurality of image domains. The generative machine-learning model can generate a plurality of morph maps each corresponding to one of the respective plurality of image domains. The one or more circuits can present, using a display device, the plurality of output images.

In some implementations, the one or more circuits can update/train the generative machine-learning model by applying the input data to a generative neural network of the generative machine-learning model to generate a set of output features. In some implementations, the one or more circuits can update/train the generative machine-learning model by applying the plurality of morph maps to the set of output features to generate a set of morphed output features. In some implementations, the one or more circuits can update/train the generative machine-learning model based at least on a plurality of outputs of a respective plurality of discriminator models that respectively receive the plurality of output images as input. In some implementations, each of the respective plurality of discriminator models corresponds respectively to one of the respective plurality of image domains.

In some implementations, each of the respective plurality of image domains correspond to a geometrically different domain. In some implementations, the plurality of morph maps each comprises a pixel-wise transformation vector. In some implementations, the generative machine-learning model comprises a plurality of rendering layers updated to generate the plurality of output images. In some implementations, the plurality of rendering layers receives a sum calculated based at least on a set of morphed features. In some implementations, the plurality of rendering layers comprise at least one shared weight value. In some implementations, the generative machine-learning model comprises a plurality of layers, at least one layer of the generative machine-learning model being a convolution layer.

At least one other aspect is related to a processor. The processor can include one or more circuits. The one or more circuits can determine, using a generative machine-learning model and based at least on input noise data, a plurality of output images, each corresponding to one of a respective plurality of image domains. The generative machine-learning model can generate a plurality of morph maps, each corresponding to one of the respective plurality of image domains. The one or more circuits can update/train the generative machine-learning model based at least on a plurality of outputs from a respective plurality of discriminator models. Each of the respective plurality of discriminator models can correspond respectively to one of the respective plurality of image domains.

In some implementations, the generative machine-learning model comprises a pre-trained generative neural network. In some implementations, the generative neural network comprises a variational autoencoder. In some implementations, the generative neural network comprises a generative adversarial network. In some implementations, the generative machine-learning model is, or comprises, any combination of one or more of: a pre-trained generative neural network; a variational autoencoder; and/or a generative adversarial network. In some implementations, each of the respective plurality of image domains corresponds to a geometrically different domain. In some implementations, the plurality of morph maps each comprises a pixel-wise transformation vector. In some implementations, the plurality of morph maps are generated using at least a first layer of the generative machine learning model, and the one or more circuits can update the generative machine-learning model by applying the plurality of morph maps to a set of features generated by at least a second layer of the generative machine-learning model.

Yet another aspect of the present disclosure is related to a method. The method can include generating, by using one or more processors, input data according to a noise function. The method can include determining, using the one or more processors and a generative machine-learning model, based at least on the input data, a plurality of output images each corresponding to one of a respective plurality of image domains. The generative machine-learning model can generate a plurality of morph maps each corresponding to one of the respective plurality of image domains. The method can include presenting, using the one or more processors and using a display device, the plurality of output images.

In some implementations, the method can include updating/training/establishing, by using the one or more processors, the generative machine-learning model by applying the input data to a generative neural network of the generative machine-learning model to generate a set of output features. In some implementations, the method can include updating, by using the one or more processors, the generative machine-learning model by applying the plurality of morph maps to the set of output features to generate a set of morphed output features.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for performing generative AI operations using a large language model (LLM), a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for controllable trajectory generation using neural network models are described in detail below with reference to the attached drawing figures, wherein:

FIG. 1 is a block diagram of an example system that implements multi-domain generative adversarial networks with learned warp fields, in accordance with some embodiments of the present disclosure;

FIG. 2 is a block diagram of an example architecture of a generative machine-learning model that utilizes learned warp fields, in accordance with some embodiments of the present disclosure;

FIG. 3 depicts a comparison of output images that show the effect of using a morph map of a target domain map while keeping the source domain fixed, in accordance with some embodiments of the present disclosure;

FIG. 4 shows examples of outputs produced from cross-domain interpolation, in accordance with some embodiments of the present disclosure;

FIG. 5 shows a comparison of output images of different machine-learning models including the generative machine-learning models described herein, in accordance with some embodiments of the present disclosure;

FIG. 6 shows examples of how edit vectors are transferred across multiple domains, in accordance with some embodiments of the present disclosure;

FIG. 7 shows examples of zero-shot segmentation transfer utilizing the machine-learning models described herein, in accordance with some embodiments of the present disclosure;

FIG. 8 shows comparisons of image-to-image translation results produced using the machine-learning models described herein and other machine-learning models, in accordance with some embodiments of the present disclosure;

FIG. 9 shows a comparison of outputs from the machine-learning models described herein and outputs from other fine-tuned machine-learning models, in accordance with some embodiments of the present disclosure;

FIG. 10 is a flow diagram of an example of a method for executing multi-domain generative adversarial networks having learned warp fields, in accordance with some embodiments of the present disclosure;

FIG. 11 is a block diagram of an example content streaming system suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

This disclosure relates to systems and methods that train/update and execute multi-domain generative adversarial networks that utilize learned warp fields. At a high level, a computing system can extend the functionality of a pre-trained generative adversarial network by incorporating additional domain-specific morph layers during fine-tuning. Features for multiple spatial resolutions generated by the GAN can be utilized by the domain-specific morph layers to modify the geometry embedded in the features for multiple target domains.

Generative machine-learning models, such as GANs, are a class of deep learning models used for generating new data samples, such as images, that resemble (or are otherwise based on) other data (e.g., data that the models “learn” from). As used herein, deep learning refers to neural networks that have three or more layers, and can be especially adept at learning from large datasets. Generative machine-learning models may be utilized, for example, to generate images, perform image editing, inverse rendering, style transfer, image-to-image translation, and semi-supervised learning. GANs may be updated/trained on individual domains, or classes of data, but often struggle to generalize to many domains. For example, generative machine-learning models may be updated/trained to generate images of human faces from input data. As used herein, related domains are domains with data sharing certain features, such as semantic characteristics. Although different domains may share similar semantics and other characteristics, updated/trained generative machine-learning models are unable to generate aligned data samples across different domains simultaneously.

This is because the geometry of the output data corresponding to different target domains can vary significantly even though the domains may share similar semantics and other characteristics. For example, a face of a human is significantly different geometrically from a face of a cat or a dog. As the geometric differences between different domains increase, so does the difficulty in utilizing conventional techniques to update/train a generative machine-learning model that produces simultaneous outputs corresponding to the different domains.

To address these challenges, the systems and methods described herein provide techniques to update/train and execute a shared generative machine-learning model that includes morph maps that geometrically deform and adapt feature maps produced by an underlying generative network. By sharing generative network layers, the semantic properties learned by the model can be shared across all modeled domains, while the geometric differences are still correctly reflected due to the additional, domain-specific morph operations. The generative machine-learning model described herein can include a shallow convolutional network that renders the morphed features into correctly stylized and geometrically aligned outputs that are also semantically consistent across multiple domains.

To update/train the generative machine-learning models described herein, a generative neural network (e.g., a GAN, etc.) is first pre-trained/implemented on an initial domain that includes semantic features that are shared by other target domains for the generative machine-learning model. The generative neural network can be pre-trained/pre-configured using any suitable machine-learning technique and may include a GAN learning or a variational autoencoder (VAE) framework. Once the generative neural network has been pre-trained, the generative machine-learning model, including the generative neural network, can be fine-tuned to produce simultaneous outputs. The generative machine-learning model includes a morph network, which receives intermediate features produced by the generative neural network as input and produces corresponding morph maps for each target domain as output.

The intermediate features may include semantic information and fine-grained edge information. The intermediate features are provided as input to the morph network of the generative machine-learning model during fine-tuning to produce corresponding morph maps for each target domain. The morph maps are used to transform the intermediate features to produce morphed features for each target domain, which are subsequently provided to rendering layers (which are also updated/trained during the fine-tuning process) that respectively correspond to and produce a respective output image for each target domain.

In the example of updating/training a GAN, the output images are provided as input to respective discriminator models, which are updated/trained concurrently with the generative machine-learning model to receive images and generate a prediction of whether the input image was a real image or generated by the generative machine-learning model. The training set for each discriminator model can include real images corresponding to the target domain and images generated corresponding to rendering layers of the generative machine-learning model. The output of the discriminator model can be utilized to update/train the layers of the generative machine-learning model. Using this process, the generative machine-learning model can be updated/trained to learn the geometric differences between domains in an unsupervised manner.

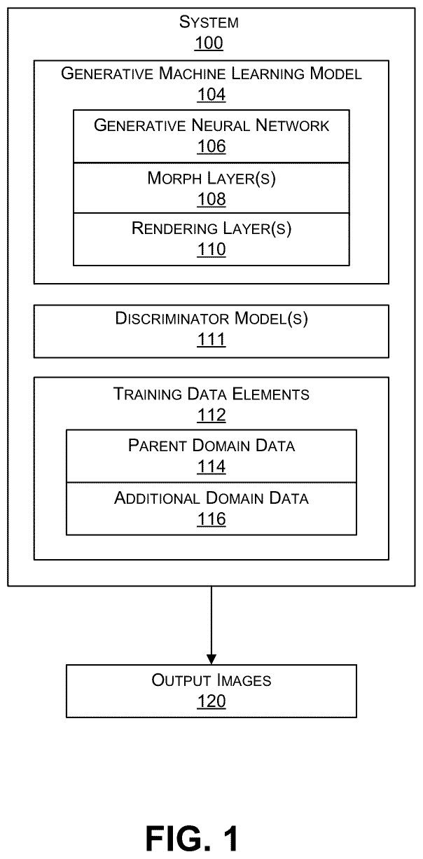

FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine-learning model), operation, routine, logic, or instructions to perform functions such as configuring generative machine-learning model(s) 104 as described herein, such as to configure generative networks to simultaneously generate aligned images from multiple domains having geometric differences.

The system 100 can train, update, or configure one or more generative machine-learning models 104. The generative machine-learning model 104 can include a generative neural network 106 and one or more morph layers 108. The generative machine-learning model 104 may receive noise data or other data as input and can simultaneously generate aligned image samples from multiple related domains (e.g., once updated/trained using the parent domain data 114 and the additional domain data 116). The generative neural network 106 of the generative machine-learning model 104 may include a GAN, a VAE, or another of suitable generative neural network.

The generative neural network 106 can include an input layer, one or more output layers, and/or one or more intermediate layers, such as hidden layers, which can each have respective nodes. The generative neural network 106 may include, or may be generated from, a pre-trained neural network, such as a pre-trained network that is updated/trained on the parent domain data 114 corresponding to a first image domain. Image domains refer to spaces of possible images that may share geometric and semantic similarities (e.g., images of a similar category). For example, image domains may include images of human faces, images of different types of cars, images of cat faces, images of wildlife, or other types of images that share semantic and geometric similarities, or otherwise depict similar categories of content.

The generative neural network 106 may be a pre-trained neural network that is updated, trained or fine-tuned on a single image domain, such as an image domain represented by the parent domain data 114. Conventional generative neural network updating/training techniques may use approaches such as fine-tuning a pre-trained generative network, which loses the ability to sample from the parent domain, or, more generally, multiple domains at the same time. As such, the generative neural network 106, on its own, may be unable to simultaneously generate aligned samples from multiple image domains (e.g., which may vary geometrically, but not necessarily semantically). To address these issues, the system 100 implements the generative machine-learning model 104 to include one or more morph layers 108, which receive the output of the generative neural network 106 and generate corresponding morph maps that can be used to geometrically deform and adapt the features output by the generative neural network 106.

In particular, the one or more morph layers 108 can be updated/trained to predict domain-specific morph maps which warp the output features of the generative neural network 106 according to different geometries of different image domains for which the generative machine-learning model 104 is updated/trained (e.g., image domains corresponding to the additional domain data 116). In some implementations, the generative machine-learning model 104 includes one or more additional rendering layers 110 (e.g., convolutional neural network layers), which can generate correctly stylized and geometrically aligned outputs based at least on the morphed features. The output images produced by the generative machine-learning model 104 can be semantically consistent across multiple domains.

One advantage of the generative machine-learning model 104 is an ability to generate aligned output images simultaneously based at least on input data (e.g., noise data). Many related domains may have similar semantics and characteristics, such as animal faces or face paintings. Aligned images may be images that share common attributes and conditions across domains, such as pose and lighting. By leveraging a single pre-trained generative neural network 106, the generative machine-learning model 104 provides computational advantages by sharing weights across domains. Additionally, the generative machine-learning model 104 may be trained, updated, or fine-tuned to a variety of applications, such as transferring segmentation labels from one domain to another, in which such information may not be available. Additional applications for the generative machine-learning model 104 include expressive image editing across different domains, image-to-image translation across domains, and zero-shot semantic segmentation transfer across domains.

In some implementations, the generative neural network 106 may be a pre-trained neural network, which is extended via the one or more morph layers 108 to generate simultaneous outputs across multiple, geometrically distinct domains. In some implementations, the generative neural network 106 includes a GAN, such as a model based at least on StyleGAN2, which is configured to produce multiple output features that are provided as input to the one or more morph layers 108, as described in further detail herein.

The system 100 can configure the generative machine-learning model 104 according to multiple image domains, which may be included in the training data elements 112. The training data elements 112 include the parent domain data 114 and additional domain data 116. The system 100 can configure the generative machine-learning model 104 using any suitable generative machine-learning techniques, including variational auto encoders or generative adversarial networks. Configuring the generative machine-learning model 104 may include updating the weights and biases according to a loss value calculated according to the techniques described herein. For example, updating the generative machine-learning model 104 may include updating weights, biases, or other trainable parameters of at least the one or more morph layers 108. In some implementations, the parameters of the generative neural network 106 may be pre-trained, and not updated based at least on the training process for updating the generative machine-learning model 104 to generate aligned samples from multiple image domains.

The system 100 can operate using the training data elements 112 (e.g., training data images), which may be retrieved from one or more databases or sources of training data. The training data elements 112 include parent domain data 114 and additional domain data 116. The parent domain data 114 may include a set of images from a parent domain upon which the generative neural network 104 has been pre-trained. In some implementations, the system 100 may update/train the generative neural network 106 using a suitable training technique, such as generative adversarial training using the parent domain data 114. The parent domain data 114 may be a large-scale dataset that includes multiple images that share geometric, semantic, and categorical similarities.

The additional domain data 116 may include multiple image datasets for each additional domain for which the generative machine-learning model 104 is to be updated/trained. The image datasets of the parent domain data 114 and each domain of the additional domain data 116 may be large-scale image datasets that include images that share common characteristics or features specific to each domain, such as objects, scenes, or styles. The images from each domain of the parent domain data 114 and the additional domain data 116 may be diverse within said domain to ensure the generative machine-learning model 104 is updated/trained according to a wide range of features and variations within each domain.

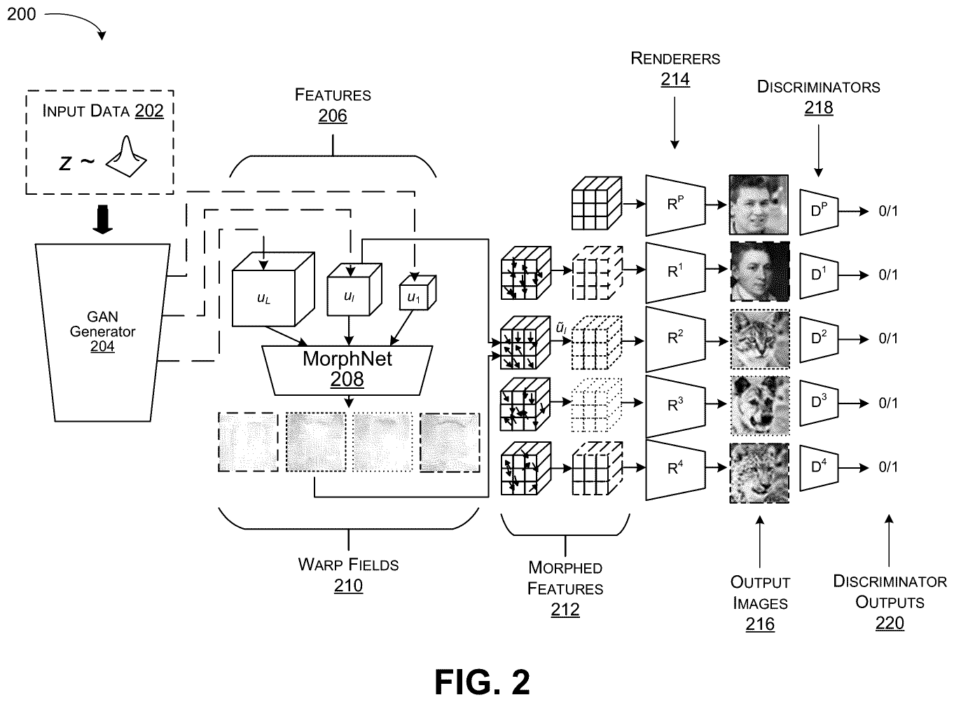

In the example training process described herein, the set of datasets for domains to be updated/trained may be referred to as D={π^{P}, π¹, . . . , π^{N}}, where π^{P} is refers to the parent image dataset of the parent domain included in the parent domain data 114. The one or more morph layers 108 of the generative machine-learning model 104 can include domain-specific morph layers, which may be represented herein as M^{1, . . . , N}. As described herein, the generative machine-learning model 104 can include one or more rendering layers 110 (sometimes represented herein as R^{1, . . . , N}), which may be domain-specific rendering layers. The rendering layers 110 are described in further detail in connection with FIG. 2.

The generative machine-learning model 104 may be configured/implemented by the system 100 to receive input data (e.g., noise generated from a noise distribution), and produce one or more output images 120. The output images 120 may each correspond to a respective domain upon which the generative machine-learning model 104 has been updated/trained, including the domain represented by the images of the parent domain data 114 and each domain represented by the datasets included in the additional domain data 116.

To generate the output images 120, the system 100 can generate noise data (e.g., by sampling a vector z˜p(z), where p(z) is a normal distribution, etc.) from a standard normal distribution and provide the noise data as input to the generative neural network 106. As described herein, the generative neural network 106 can be a pre-trained generative model that is updated/trained using the image dataset of the parent domain included in the parent domain data 114. The system 100 can execute the generative neural network 106 by propagating the input noise data through each layer of the generative neural network 106, and computing the mathematical operations of each layer, and providing the result of the computations as input to the next layer until an output is generated. The generative neural network 106 can be pre-trained to produce an output image corresponding to the parent domain and one or more intermediate features (described in further detail in connection with FIG. 2).

The intermediate features (e.g., the features 206 of FIG. 2) can be provided as input to the one or more morph layers 108, which may themselves form one or more neural networks. The morph layers 108 may correspond to the respective additional domains of the additional domain data 116. The intermediate features generated via the generative neural network 106 include information that may be utilized to generate aligned samples across geometrically distinct domains, including semantic content as well as fine-grained edge information. These features can be utilized as input to the morph layers 108, which generate domain-specific morph maps (e.g., each corresponding to one of the target domains represented in the additional domain data 116) that can modify the geometry embedded in the features to be suitable for each target domain. Further details of the morph layers 108 are described in connection with FIG. 2 (e.g., the morph net 208 of FIG. 2). As described in further detail in connection with FIG. 2, the morph layers 108 can generate morph maps [symbol] _{Δ}^{d}, which represent the relative horizontal and vertical direction that each pixel would get its value from (e.g., a (p, q) position in a 3-dim spatial tensor, as described in further detail herein).

The system 100 can then perform a morph operation to morph each of the features produced by the generative neural network 106 operation that bilinearly interpolates the features to generate respective sets of morphed features, which are geometrically transformed to be suitable for each additional domain d represented in the additional domain data 116. The system 100 can then provide the geometrically transformed features as input to respective rendering layers 110 for each target domain d represented in the additional domain data 116, which produce the output images 120. Each of the output images 120 correspond to a respective target domain. The output images 120 may each include respective RGB images.

The system 100 can utilize any suitable training process to update one or more trainable parameters of the generative machine-learning model 104. For example, the system 100 can use a gradient descent operation, such as stochastic gradient descent or another optimization algorithm, to update the trainable parameters of the morph layers 108, the rendering layers 110, or other layers or trainable parameters of the generative machine-learning model 104. In the example where the generative machine-learning model 104 is updated/trained as generative adversarial network, the system 100 can update/train the generative machine-learning model 104 using separate discriminator models 111 with the same architecture for each domain represented in the parent domain data 114 and the additional domain data 116. The system 100 can calculate/determine a suitable loss value for updating/training the parameters of the generative machine-learning model 104, such as non-saturating logistic loss. In some implementations, R1 regularization and path-length regularization may be utilized to update/train the generative machine-learning model 104.

The system 100 can utilize equal loss weightings for the morph layers 108 corresponding to each domains. In implementations that utilize low-data regime training, the system 100 may weigh losses by |π^{d}|/maxₗ|π^{l}|, where |π^{d}| is the number of training examples in the corresponding domain d. Such weighting may be utilized such that the features generated by the generative neural network 106 are mostly learned from data-rich domains while domains with significantly less data leverage the rich representation with domain-specific layers. As described herein, the generative neural network 106 can be initialized from pre-trained weights on the parent domain represented in the images of the parent domain data 114.

In some implementations, the system 100 can initialize each of the discriminator model(s) 111 from the same pre-trained model helped stabilize training. The system 100 can configure one discriminator model 111 for each target domain (e.g., the domains represented in the parent domain data 114 and the additional domain data 116). Each of the one or more discriminator models 111 can be domain-specific binary classifiers that are updated/trained by the system 100 concurrently with the generative machine-learning model 104 to distinguish between real samples (e.g., images) from the training data elements 112 and samples generated by the generative machine-learning model 104. The discriminator model(s) 111 may include convolutional neural networks that receive image data as input. The system 100 can execute the discriminator model(s) 111 by propagating the input data through each layer of the discriminator model(s) 111, to produce an output value (e.g., a binary output, a probability, or score) that indicates whether the input data is part of the training data elements 112 or generated by an output layer (e.g., a rendering layer 110) of the generative machine-learning model 104).

During training, the system 100 can update/train the generative machine-learning model 104 and the discriminator models 111 in an adversarial manner, where over time, the generative machine-learning model 104 generates samples that are more difficult for the discriminator models 111 to differentiate, while the discriminator is updated/trained to improve its predictions about whether the generated samples are included in the training data elements 112. This adversarial training process can continue until a training termination condition has been met.

The system 100 can train or otherwise update the generative machine-learning model 104 and the one or more discriminator model(s) 111 by modifying or updating one or more parameters, such as weights, biases, or other training parameters, of various nodes of each model. The system 100 can apply various machine-learning model optimization or modification operations to modify the generative machine-learning model 104 and the discriminator model(s) 111.

In some implementations, the system 100 may hold certain parameters of the generative machine-learning model 104 and/or the discriminator model(s) 111 constant. For example, the system 100 may freeze/maintain the parameters of the first three layers of discriminators and the generative neural network 106, such that the weights or other parameters of said layers are not updated during training. In some implementations, the system 100 may share one or more weights, trainable parameters, or layers, across multiple rendering layers 110. For example, the system 100 may share the weights of k rendering layers 110 across the domains represented in the parent domain data 114 and the additional domain data 116. Sharing such layers can promote rendering a similar style(s) (e.g., colors, etc.) across output images 120 for different domains.

The number of shared parameters of the rendering layers 110 may be a hyperparameter of the generative machine-learning model 104, which can be adjusted at model generation to increase or decrease how similar in style the output images 120 for each domain becomes. In some implementations, the hyper parameter k indicating the number of shared layers across the rendering layers 110 can be set to 1. In some implementations, the shared rendering layer 110 may be a 4×4 spatial resolution layer and sharing said layer may be utilized to produce similarly styled output images 120. Once generated, the system 100 can present the output images 120 using a display device, store the output images 120 in memory, such as a database, or provide the output images 120 to another computing system (e.g., via a network or a suitable communications bus or interface).

In some implementations, the system 100 uses at least some various subsets of the training data elements 112 to configure the generative machine-learning model 104 and the discriminator model(s) 111. For example, the system 100 can use different batches, or sets, of training data to update/train the models, and may allocate a portion of both the parent domain data 114 and the additional domain data 116 as a test set that is not exposed to the models during training/updating. During one iteration of training, the system 100 may execute the generative machine-learning model 104 using noise data as input as described herein to generate a set of output images 120 that each correspond to a respective domain (e.g., the parent domain and each additional domain represented in the additional domain data 116). Each output image 120 can then be provided as input to a respective discriminator model 111, which can output a prediction of whether the output image 120 was generated by the generative machine-learning model 104. The output of each discriminator model 111 can be utilized to calculate a loss for the generative machine-learning model 104. The system 100 can update/train each discriminator model 111 with corresponding training data elements 112 (e.g., images included in the parent domain data 114 and/or the additional domain data 116) for each domain, as described herein. An example dataflow diagram showing example operations of the generative machine-learning model 104 and the discriminator models 111 are shown in FIG. 2.

Referring to FIG. 2, depicted is a block diagram of an example architecture of a generative machine-learning model 200 (e.g., the generative machine-learning model 104, the discriminators 111, etc.) that generates and utilizes learned warp fields 210 to produce output images 216 (e.g., the output images 120 of FIG. 1), in accordance with some embodiments of the present disclosure. As shown, the generative machine-learning model 200 includes a GAN generator 204 (e.g., the generative neural network 106), which receives the input data 202 and produces a set of features 206. Although the GAN generator 204 is shown here as a GAN, it should be understood that the GAN generator 204 may be any suitable pre-trained generative model, such as a VAE.

The GAN generator 204 may be, for example, a pre-trained StyleGAN2 model, or another suitable generative model. For the purposes of describing how the generative machine-learning model 200 produces output data, and as described in connection with FIG. 1, the set of datasets for domains to be updated/trained is designated herein as D={π^{P}, π¹, . . . , π^{N}}, where π^{P} is a dataset from the parent domain (e.g., images included in the parent domain data 114) for the GAN generator 204 is pre-trained, and N identifies the number of additional domains upon which the generative machine-learning model 200 is to be update/trained. The datasets {π¹, . . . , π^{N}} may correspond to additional target datasets (e.g., each set of images in the additional domain data 116). Images from each dataset D may be utilized to update/train the discriminators 218 (e.g., the discriminator model(s) 111), which produce outputs that are utilized to update/train the parameters of the generative machine-learning model 200.

As shown in FIG. 2, the generative machine-learning model 200 includes the MorphNet 208, which receives the features 206 generated by the GAN generator 204 as input. The MorphNet 208 includes domain-specific morph layers M^{1, . . . , N} (e.g., each respectively corresponding to a respective additional domain). The generative machine-learning model 200 includes corresponding rendering layers R^{1, . . . , N}. In this example, the generative machine-learning model 200 further includes a rendering layer R^{p} that produces images corresponding to the parent domain.

To generate the output images 216 using the generative machine-learning model 200, noise data (e.g., a noise vector) z˜p(z) can be sampled from a standard normal distribution, which is provided as input to the GAN generator 204. In some implementations, additional input data, such as metadata defining certain features to generate, may be provided as input to cause the GAN generator 204 to generate certain types of outputs (e.g., outputs having certain characteristics, styles, etc.). The GAN generator 204 can then be executed by propagating the input data through each layer of the GAN generator 204, producing the output image I^{P} (e.g., shown as the top output image 216) and also the intermediate features 206, which may be represented herein as the u₁, . . . , u_{L} for L features in the GAN generator 204.

The generator features 206 may be stored for each spatial resolution from 2²×2² to 2^{L+1}×2^{L+1} before the final features are transformed via a 1×1 convolution layer (e.g., tRGB) that produces the output RGB values. In this example, square images with H=W=2^{L+1} are utilized for simplicity. However, it should be understood that the parameters of the generative machine-learning model 200 may be modified to accommodate images of any dimension or resolution.

The features 206 generated by the GAN generator 204 can be provided as input to the MorphNet 208 to produce domain-specific warp fields 210 (sometimes referred to herein as morph maps) that can modify the geometry embedded in the features 206 to be suitable for each target domain. The MorphNet 208 can reduce the channel dimension for each feature 206 to be smaller through a 1×1 convolution layer. The MorphNet 208 can include further layers that then upsample all reduced features to match the largest spatial resolution H×W.

In this example implementation, the upsampled features are concatenated channel-wise within the MorphNet 208 and are propagated through two 3×3 convolution layers of the MorphNet 208. In some implementations, a fixed 2-dimensional sinusoidal positional encoding is added to the merged features to inject grid position information which can be useful for learning geometric biases in a dataset.

This tensor is then processed by domain-specific convolutional layers [symbol] for each domain [symbol] within the MorphNet 208. The convolutional layers [symbol] produce a H×W×2 morph map [symbol] (shown here as the warp fields 210). Each of the warp fields 210 may include an (x, y) vector transformation for each position (e.g., pixel) within the H×W feature maps 206. A respective warp field 210 may be generated for each additional domain d. The values of the warp fields 210 can be normalized between [−1/η, 1/η], for example, through a tanh activation function, where 11 is a hyperparameter that controls the maximum displacement the morphing operation are allowed to produce. The warp fields 210 may be represented mathematically herein as [symbol] , which represents the relative horizontal and vertical direction that each pixel would get its value from (e.g., where a pixel is a (p, q) position in a 3-dim spatial tensor). In the various examples described in further detail herein, the morph hyperparameter is set to η=3, such that each pixel can move at most ⅙ of the image size in the x and y direction. The hyperparameter can be adjusted depending on the geometric gap between domains.

The warp fields 210 can then be utilized to differentiably morph each of the generated features 206 to generate the corresponding morphed features 212. To do so, a 2D sampling grid can be initialized from an identity transformation matrix, and normalized between [−1, 1]. The sampling grid can be generated to have the same shape as the warp fields 210, and each pixel (p, q) in the sampling grid can be initialized to include the absolute position (x, y) of the source pixel that will be morphed into (p, q). For example, if pixel (p, q) has value (−1, −1), the vector at the top left corner of the corresponding feature map 206 will be morphed into (p, q). The warp field 210 is added to the grid. The resulting grid is represented mathematically herein as Γ∈ [symbol] ^{H×W×2}. The warp fields 210 are pixel-wise morphing maps, which provide precise control for fine-detailed morphing.

To generate the morphed features 212, the following morph operation that bilinearly interpolates features is performed for each layer l of the features 206.

$${\tilde{u}}_{l}^{p q} = {\sum }_{n}^{{H}_{l}} {\sum }_{m}^{{W}_{l}} {u}_{l}^{n m} max ( 0 , 1 - \vert {x}^{p q} - m \vert ) max ( 0 , 1 - \vert {y}^{p q} - n \vert )$$

In the above equation, ũₗ^{pq} is the corresponding morphed feature 212 vector at pixel (p, q) for layer l, uₗ^{nm} is the source feature 206 vector prior to the morph operation at pixel (n, m), and (x^{pq}, y^{pq}) is the sample point in the grid F for the pixel (p, q), assuming unnormalized grid coordinates for ease of presentation. In this example, the grid F is bilinearly interpolated to match the spatial dimension of each layer (Hₗ, Wₗ). The morphed features 212 (represented mathematically herein as {ũ₁, . . . , ũ_{L}}_{d} for each domain d) are then geometrically transformed to be suitable for each domain d.

Each of the morphed features 212 is then provided as input to the renderers 214 (e.g., the rendering layers 110 of FIG. 1). The renderers 214 can include domain-specific convolution layers R^{d} that are updated/trained to produce the RGB output images 216 (e.g., the output images 120 of FIG. 1). In some implementations, the input and output of the renderers 214 can be summed together using one or more skip connections to produce the output images 216. The renderers 214 may be automatically updated/trained to correct small unnatural distortions caused by the feature morphing process. An example algorithmic representation of the foregoing operations is shown in Algorithm 1 below:

Algorithm 1: Inference Step for Generative
Machine-Learning Model 200

```
function FORWARD (z) [symbol]
  , ... , [symbol]   = G(z)
  u = MergeFeatures ( [symbol]   , ..., [symbol]   )
  for [symbol]   ∈ (1, ..., [symbol]   ) do [symbol]
    = [symbol]   (u) [symbol]   Get morph map for domain [symbol]
    { [symbol]   , ... , [symbol]   }d = Morph [symbol]    , [symbol]   for all l
    I [symbol]   = [symbol]   ( [symbol]   , ... , [symbol]   )
  return I¹, ... , [symbol]    , I^{P}
```

Once the output images 216 have been generated by executing the renderers 214 of the generative machine-learning model 200, the output images 216 can be provided as input to the discriminators 218 (e.g., the discriminator models 111 of FIG. 1). As described herein, the discriminators 218 may be machine-learning models that are updated/trained with the generative machine-learning model 200 to predict whether an input image is part of a training data set (e.g., the training data elements 112) or is generated by the generative machine-learning model 200. The discriminator outputs 220 for each domain can be utilized to calculate corresponding loss values for each of the morph layers of the MorphNet 208. For example, training the generative machine-learning model 200 may utilize a non-saturating logistic loss, R1 regularization, and path-length regularization.

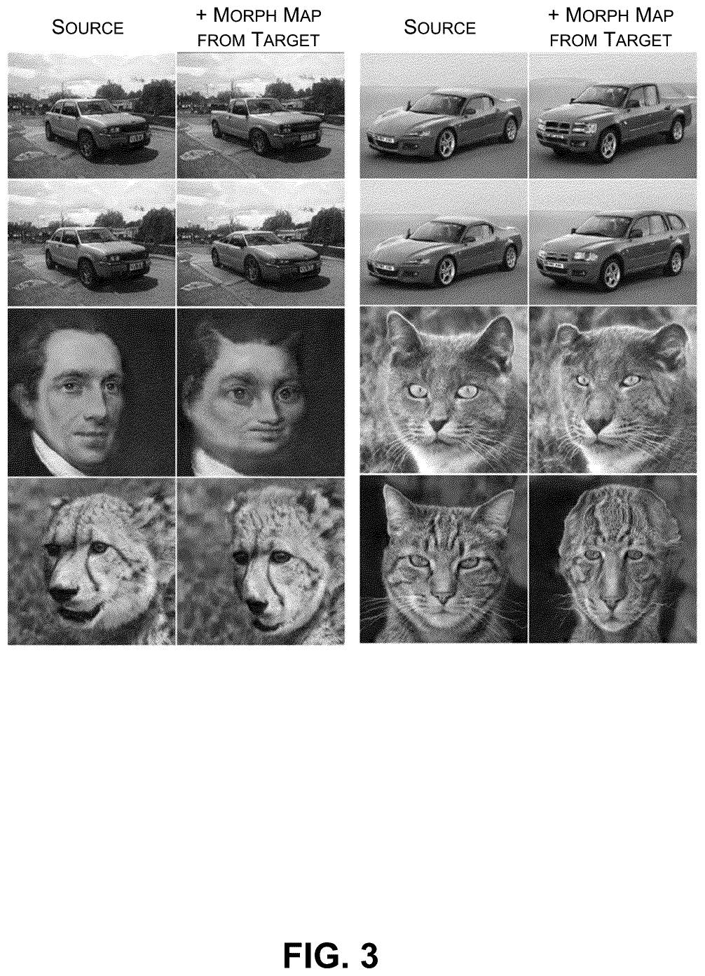

FIGS. 3, 4, 5, 6, 7, 8, and 9 provide example outputs for experiments performed using an example implementation of the generative machine-learning models updated/trained according to the techniques described herein.

Referring to FIG. 3, depicted is an example comparison of images that show the effect of using a morph map of a target domain map while keeping the source domain fixed, in accordance with some embodiments of the present disclosure. In this example experiment, the effect of using the target domain t's morph map (e.g., a warp field 210) for a source domain s. Specifically, the morph map M_{Δ}^{s} is swapped with M_{Δ}^{t} and rendered (e.g., using the corresponding renderer 214) for domain s. In the example dataset including images of cars shown in the top two rows, the domains have similar texture, and therefore the cars from source domains (e.g., indicated as the “Source” column) can be smoothly transformed towards the target domain (e.g., indicated in the “+Morph Map from Target” column). In the example dataset including images of faces (e.g., paintings of human faces and cat faces) and shown in the bottom two rows, the domains have similar texture, and therefore the warp fields produce renderings such as a cat-shaped human face. These results demonstrate how the generative machine-learning models described herein can successfully learn the distinct geometries of each domain.

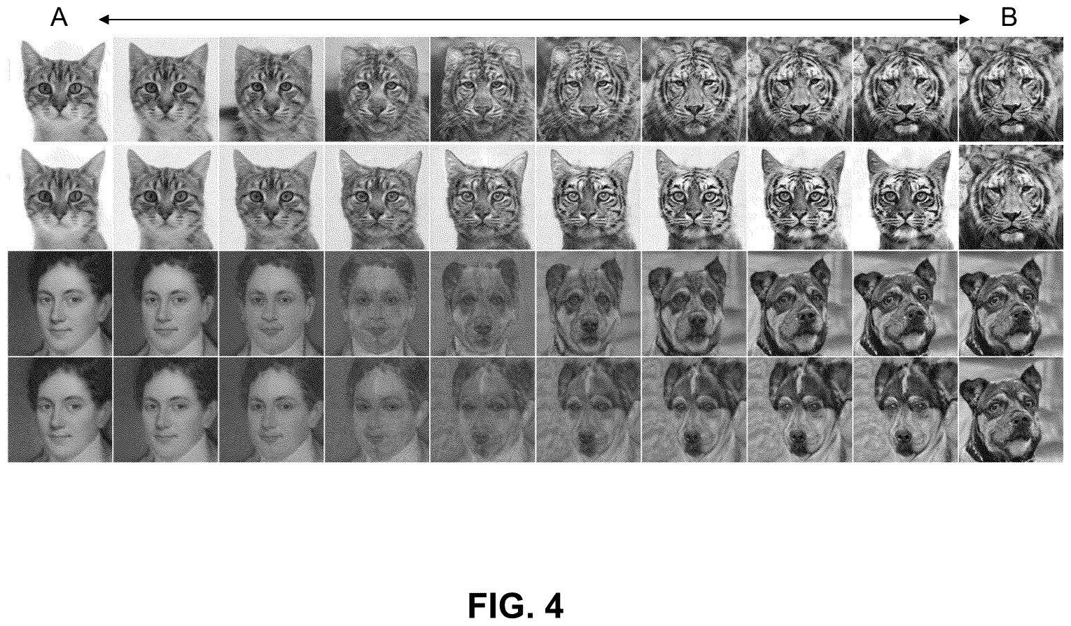

Referring to FIG. 4, depicted are examples of outputs produced from cross-domain interpolation, in accordance with some embodiments of the present disclosure. In this example, the domain-specific layers of the generative machine-learning models described herein can be interpolated to continuously interpolate two different domains. The morph maps (e.g., warp fields 210) are utilized to show whether the models correctly learned the geometric differences. As shown, in this example, two latent vectors A and B were sampled, and domain layer weights as well as the latent vectors were linearly interpolated. The images shown in FIG. 4 demonstrate that the generative machine-learning models described herein are capable of performing cross-domain interpolation, and by fixing a first domain's (shown as domain “A”) morph map (e.g., the warp field 210 corresponding to domain A) during interpolation, it maintains the geometric characteristic of domain A while adapting to the texture of a second domain, shown as “B”. These images demonstrate how geometry is disentangled from rendering, and that the generative machine-learning models described herein can be used for image editing applications such as domain transformations (e.g., transforming a cat to look like a tiger, as shown).

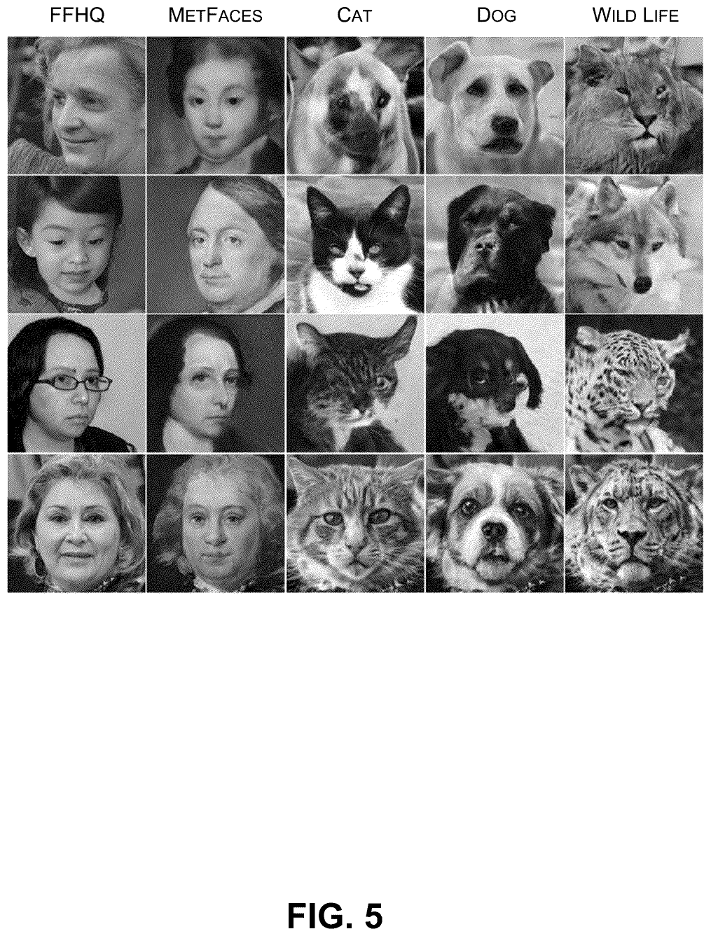

Referring to FIG. 5, depicted is a comparison of output images of different machine-learning models including the generative machine-learning models described herein, in accordance with some embodiments of the present disclosure. In the example outputs shown in FIG. 5, each row corresponds to a sample from a corresponding generative machine-learning model. The top row corresponds to output from a pre-trained Domain-Conditional StyleGAN2 (*DC-StyleGAN2) model is a modified StyleGAN2 model that takes a one-hot encoded domain vector as an input, with added extra layers for class conditioning. The second row includes outputs from DC-StyleGAN2 without pre-training and without the added layers for class conditioning. In these examples, the DC-StyleGAN2 and the *DC-StyleGAN2 models utilize a one-hot vector that is embedded through a linear layer, concatenated with the output of the mapping network, merged with a linear layer and fed into the generator of each model. The third row shows outputs from the generative machine-learning models described herein (e.g., the generative machine-learning model 104, the generative machine-learning model 200, etc.), without executing the morphing operation. The fourth row shows outputs from the generative machine-learning models described herein (e.g., the generative machine-learning model 104, the generative machine-learning model 200, etc.), including execution and application of the morphing operation, as described in connection with FIG. 2.

Based at least on these examples, it is shown that the *DC-StyleGAN2 model, which fine-tunes a pre-trained model, has difficulties learning class-conditioning information, as can be seen in its low classification accuracy. Additionally, the third row shows that even without morphing, the generative machine-learning models described herein produce aligned poses due to the shared use of some generator features, but has trouble sharing features across domains because of their geometric differences. In contrast, the generative machine-learning models described herein utilizing the morph operations leverage domain-specific layers but still benefit from sharing the entire stack of features due to the geometric morphing, and therefore achieves the best overall sample quality and accuracy on all datasets, as shown in the bottom row.

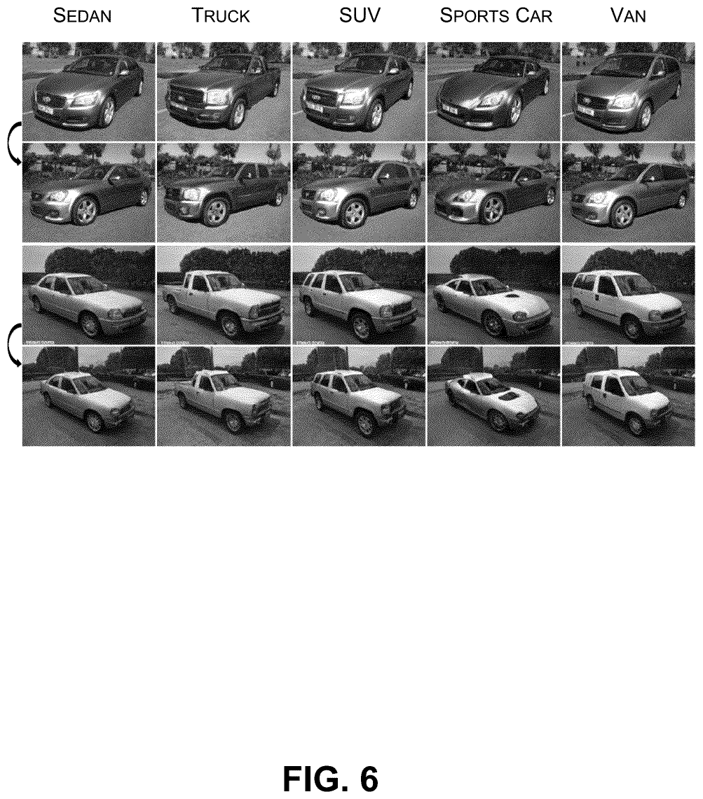

FIG. 6 shows examples of how edit vectors are transferred across multiple domains, in accordance with some embodiments of the present disclosure. The machine-learning models described herein can be utilized to identify or generate edit vectors that can modify an output image in a semantically meaningful way by pushing the latent vector of a generative neural network into certain directions. The aligned cross-domain samples generated by the generative machine-learning models described herein can be utilized to discover edit vectors that transfer across domains. An approach such as Self-Supervised Feature Attribution (SeFa) can be utilized to find edit vectors in the generative machine-learning models described herein. Such techniques can be utilized to discover semantically meaningful edit directions or “edit vectors” in the latent space of generative adversarial networks, which can be utilized for controlled image manipulation or editing. Meaningful vectors such as rotation, zoom, lighting, and elevation, among others, may be identified from the generative machine-learning models described herein.

Some examples of how edit vectors can be transferred across all domains are shown in FIG. 6. In FIG. 6, each pair of rows shows an example application of a corresponding edit vectors identified from the generative machine-learning models described herein that can be transferred across all domains for which the generative machine-learning models were updated/trained. The top two rows show the application of a rotation edit vector, the bottom two rows show the application of a zoom edit vector. Each of said edit vectors was identified from trained machine-learning models according to the techniques described herein. The machine-learning models described herein may be utilized to generate any type of edit vector, including, for example, color edit vectors.

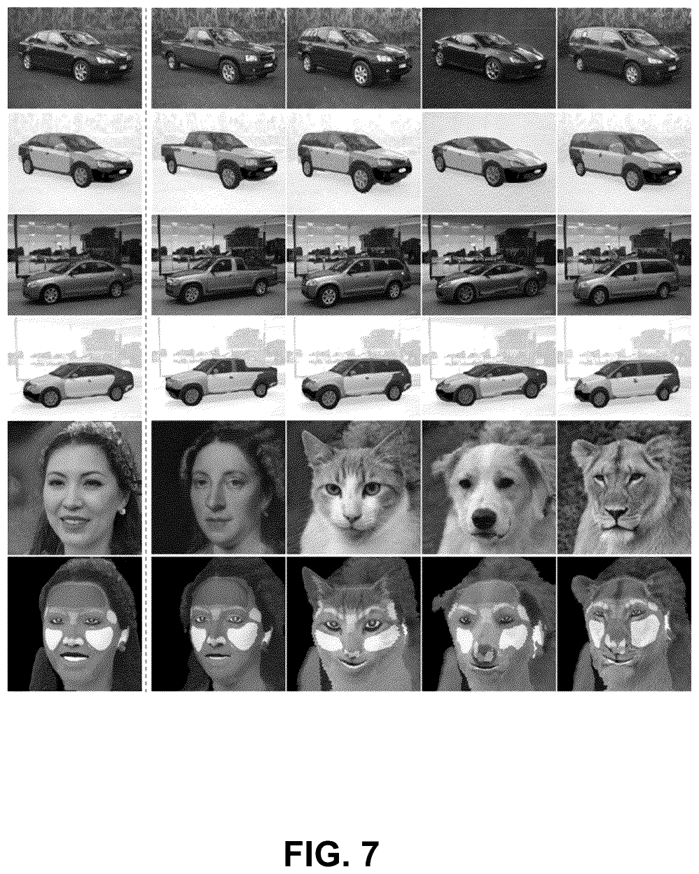

Referring to FIG. 7, depicted are examples of zero-shot segmentation transfer utilizing the machine-learning models described herein, in accordance with some embodiments of the present disclosure. Assuming there exists a method that can output a segmentation map for images from the parent domain, it is possible to zero-shot transfer the segmentation mask to all other domains using one or more learned morph maps (e.g., the warp fields 210) generated by the generative machine-learning models described herein. The morph operation described in connection with FIG. 2 can be applied directly on the segmentation map with MA after bilinearly interpolating the morph map to match the size of the mask.

As the morph map MA captures the geometric differences between domains, the morph map can be used MA to transfer the segmentation masks of the parent domain across one or more target domains, as shown in FIG. 7. In FIG. 7, the masks in the leftmost column are transferred to other domains using the morph maps MA. To measure the quality of the segmentation transfer, a pre-trained segmentation network was utilized to pseudo-label detailed car parts. The agreement between the pseudo-label and transferred segmentations from the sedan class are compared, and the results are shown in Table 1 below. In Table 1, the baseline measures mean intersection over union (IoU) using the segmentation from the sedan class for all classes without morphing, which can serve as a baseline because the generative machine-learning models produce aligned samples whose poses may be similar. The zero-shot segmentation produced using the morph maps described herein show much higher agreement with the pseudo-label, indicating the generative machine-learning models updated/trained according to the techniques described herein can correctly learn the correspondence between different car parts. Table 1 below provides a summary of these results.

TABLE 1
Mean IoU for zero-shot segmentation. Transferred segmentation
masks show high IoU with pseudo-labelled masks. (“Ours”
refers to the generative machine-learning models described herein)

| Criterion | Method | Truck | SUV | Sports Car | Van | Mean |
|---|---|---|---|---|---|---|
| mIoU (↑) | Baseline | 0.45 | 0.57 | 0.52 | 0.44 | 0.49 |
| | Ours | 0.67 | 0.74 | 0.63 | 0.64 | 0.67 |

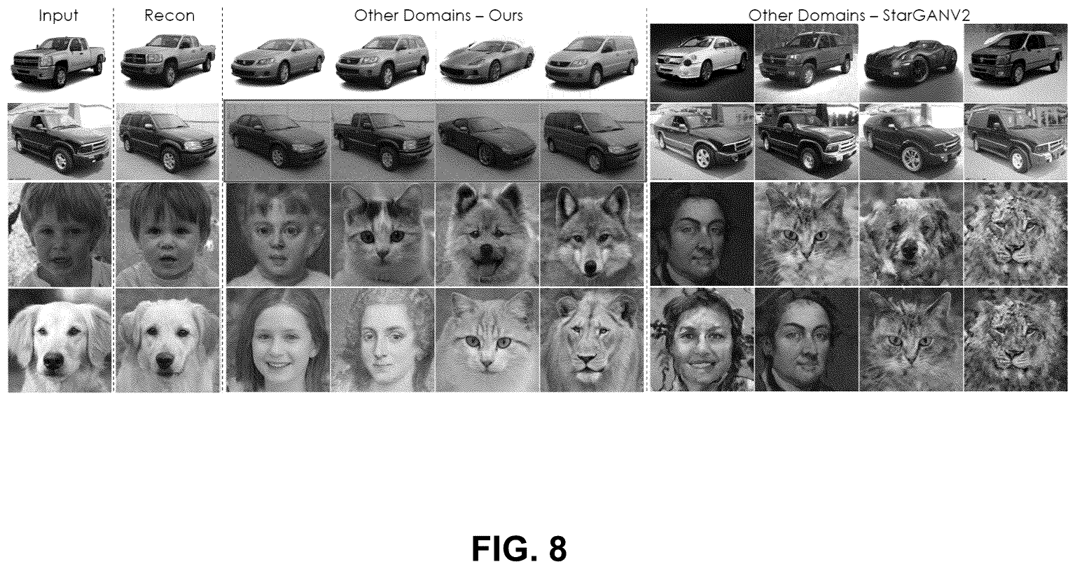

Referring to FIG. 8, depicted are comparisons of image-to-image translation results produced using the machine-learning models described herein and other machine-learning models, in accordance with some embodiments of the present disclosure. The generative machine-learning models described herein can be compatible with any suitable GAN inversion method because the generative machine-learning models described herein can include a GAN. Once an image is inverted in the latent space, the generative machine-learning models described herein can naturally be used for image-to-image translation (I2I) tasks by synthesizing every other domain with the same latent code. On an example dataset including images of cars, latent optimization was used to encode input images. In this example, the generative machine-learning models described herein outperform the other multi-domain image translation models, such as StarGANv2, for both Fréchet Inception Distance (FID) and accuracy.

The StarGANv2 model has a strong shape bias from the input image, and therefore has trouble translating to another car domain, as indicated by its low accuracy in Table 2 below. For an example dataset that includes images of faces, the StarGANv2 model performs if updated/trained only on animal faces because geometric differences between animal classes are small. However, when updated/trained on five geometrically distinct domains within the dataset, training collapses and fails to translate between human and animal faces, as represented in both Table 3 and FIG. 8. To compare with other image translation approaches, a single domain translation task was evaluated, with results summarized in Table 4. The generative machine-learning models described herein show competitive performance on a “cat-to-dog” image translation task, despite being a generative model updated/trained on all five domains together, as opposed to methods that are updated/trained to only translate between two domains. In FIG. 8, image-to-image translation results from the generative machine-learning models described herein and StarGANv2. The generative machine-learning models described herein use GAN inversion techniques to find a latent vector that can reconstruct the input image and renders the other domains.

TABLE 2
Example I2I performance, where each column evaluates quality of samples
translated from other domains to the column's domain. (“Ours”
refers to the generative machine-learning models described herein).

| | | | | | Sports | | |
|---|---|---|---|---|---|---|---|
| Criterion | Method | Sedan | Truck | SUV | Car | Van | Mean |
| FID (↓) | StarGANv2 | 28.1 | 35.0 | 41.0 | 20.7 | 42.2 | 33.4 |
| | Ours | 26.7 | 25.3 | 26.6 | 25.3 | 35.9 | 38.0 |
| Acc. (↑) | StarGANv2 | 48.5% | 62.2% | 58.1% | 84.4% | 63.5% | 63.3% |
| | Ours | 94.1% | 90.0% | 80.0% | 91.6% | 76.2% | 86.4% |

TABLE 3
Example I2I performance (FID), where a generative machine-learning
model is updated/trained according to the techniques described herein
on five domains for both rows. Other models are updated/trained only
on animals for the first row, and on all domains for the second row.

| Evaluation | | | | | |
|---|---|---|---|---|---|
| Dataset | MUNIT | DRIT | MSGAN | StarGANv2 | Ours |
| Animals | 41.5 | 95.6 | 61.4 | 16.2 | 33.1 |
| Only | | | | | |
| All Domains | — | — | — | 133.7 | 41.1 |

(“Ours” refers to the generative machine-learning models described herein)

TABLE 4
Example I2I performance (FID) on a “cat-to-dog” translation task.
Ours shows competitive performance despite being a
generative model that jointly models all domains.

| Task | MUNIT | CycleGAN | StarGANv2 | CUT | Ours |
|---|---|---|---|---|---|
| Cat → | 91.4 | 76.3 | 53.4 | 56.4 | 55.9 |
| Dog | | | | | |

(“Ours” refers to the generative machine-learning models described herein)

TABLE 5
Example performance (FID) for low data regime training.
For different amounts of data that were used, the generative
machine-learning models described herein are compared
with StyleGAN2 updated/trained on a single domain.

| Dataset | Method | 5% | 20% | 100% |
|---|---|---|---|---|
| Metfaces | StyleGAN2-single domain | 68.7 | 83.0 | 72.4 |
| | Ours-five domains | 59.7 | 40.7 | 34.7 |
| AFHQ- | StyleGAN2-single domain | 27.3 | 19.6 | 6.8 |
| Cat | Ours-five domains | 23.3 | 13.8 | 9.4 |

The generative machine-learning models described herein share features for multiple domains, which can be beneficial for domains with small amounts of data, as they can leverage the rich representations learned from other domains. The generative machine-learning models described herein can be evaluated on a first domain (e.g., the Faces domain) by varying the amount of data for sub-domains included therein (here, the MetFaces and Cat domains) while other domains use the full training data. Results from these training approaches are summarized in Table 5 above. Compared to other machine-learning techniques, the generative machine-learning models described herein achieve better FID performance when the amount of training data is small. In the example experiments summarized in Table 5, Style-GAN2 training was performed with 5% data mode-collapsed. The generative machine-learning models described herein can be combined with techniques that explicitly tackle low-data GAN training to achieve useful results.

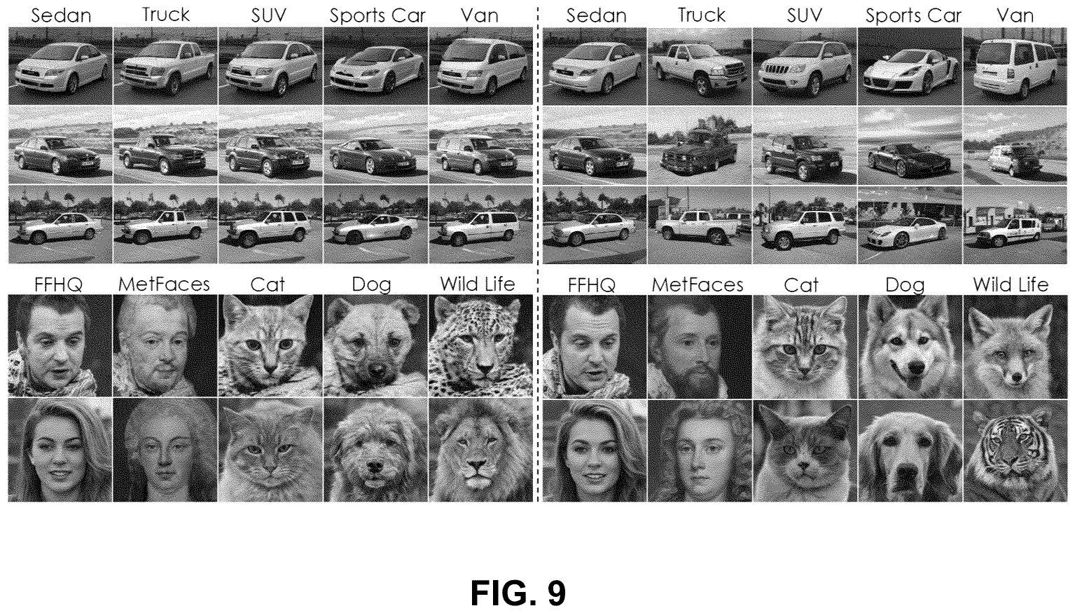

Referring to FIG. 9, depicted is a comparison of outputs from the machine-learning models described herein and outputs from other fine-tuned machine-learning models, in accordance with some embodiments of the present disclosure. In FIG. 9, the left-hand sets of images include samples generated using the generative machine-learning models described herein, and the right-hand sets of images are samples generated using fine-tuned models from the same parent model (e.g., the same parent generative neural network 106, etc.). As shown, the generative machine-learning models described herein produce consistently aligned samples across domains, while fine-tuning specializes each separate model for each domain, especially for less pre-aligned datasets.

Pre-trained generative neural networks may be fine-tuned for new target domains, but cannot be effectively updated/trained to produce samples for multiple target domains simultaneously. While these methods can achieve high image quality, fine-tuning encourages the child (e.g., fine-tuned) models to be specialized to the new domains. As a further comparison, the same parent model used by the generative machine-learning models described herein was fine-tuned for each domain. For an example dataset including faces, the fine-tuning process preserves some attributes such as pose and colors (with the same latents for original and fine-tuned models). FIG. 9 shows that the generative machine-learning models described herein achieve better alignment in terms of facial shape and exact pose.

An example dataset including images of cars data reflects more diversity in viewpoints and car placement. The fine-tuned models show different sizes, poses and backgrounds. On the other hand, the generative machine-learning models described herein produce consistently aligned cars. The viewpoint alignment is evaluated with a regression model by measuring the mean difference in azimuth and elevation between Sedan and other domains. Fine-tuning achieves 53.2 and 3.8 degrees in azimuth and elevation, respectively. Example experimental results show that the generative machine-learning models described herein achieves 21.0 and 2.2 degrees in azimuth and elevation, significantly out-performing the fine-tuning approach of other machine-learning models. As datasets become more diverse, it becomes challenging to enforce alignment without feature sharing for conventional machine-learning techniques. The generative machine-learning models described herein has an advantage of being a single model that directly produces highly aligned samples across domains while enabling a diverse set of applications.

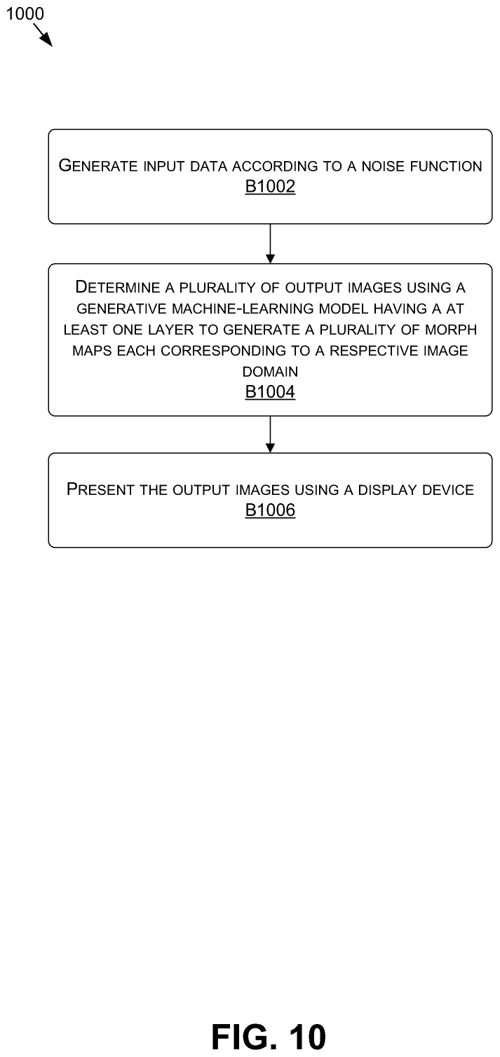

Now referring to FIG. 10, each block of method 1000, described herein, comprises a computing process that may be performed using any combination of hardware, firmware, and/or software. For instance, various functions may be carried out by a processor executing instructions stored in memory. The method 1000 may also be embodied as computer-usable instructions stored on computer storage media. The method 1000 may be provided by a standalone application, a service or hosted service (standalone or in combination with another hosted service), or a plug-in to another product, to name a few. In addition, method 1000 is described, by way of example, with respect to the system of FIG. 1, and may be utilized to execute and/or update the generative machine-learning models described herein (e.g., the generative machine-learning model 104 of FIG. 1, the generative machine-learning model 200 of FIG. 2, etc.). However, this method 1000 may additionally or alternatively be executed by any one system, or any combination of systems, including, but not limited to, those described herein.

FIG. 10 is a flow diagram showing a method 1000 for executing multi-domain generative adversarial networks having learned warp fields, in accordance with some embodiments of the present disclosure. Various operations of the method 1000 can be implemented by the same or different devices or entities at various points in time. For example, one or more first devices may implement operations relating to configuring (e.g., updating or training) the generative machine-learning models, and one or more second devices may implement operations relating to executing the generative machine-learning models to produce one or more output images. The one or more second devices may maintain the neural network models, or may access the machine-learning models using, for example and without limitation, APIs provided by the one or more first devices.

The method 1000, at block B1002, includes generating input data (e.g., the input data 202) according to a noise function. The input data may be generated, for example, by sampling from a multi-dimensional normal distribution. The noise data may include one or more noise vectors. Although various approaches described herein have described input noise data being sampled from a normal distribution, it should be understood that any type of noise function may be utilized to create noise data suitable for the techniques described herein. The noise data may be generated in part based at least on a random number generation algorithm.

The method 1000, at block B1004, includes determining, a generative machine-learning model (e.g., the generative machine-learning model 104, the generative machine-learning model 200, etc.), based at least on the input data, one or more output images (e.g., the output images 120, the output images 216). The output images can each correspond to a respective image domain. The generative machine-learning model can have at least one layer (e.g., the morph layers 108, the MorphNet 208) that generate one or more morph maps (e.g., the warp fields 210). Each of the morph maps can correspond to one of the respective image domains.

To determine the output images, a generative neural network of the generative machine-learning model can be executed using the noise data as input to generate a set of output features. The output features can be processed according to the techniques described herein, and provided as input to the one or more morph layers of the generative machine-learning model to generate the morph maps for each image domain. The morph maps can then be applied to the set of input features, as described herein, to produce one or more sets of morphed features (e.g., the morphed features 212). The morphed features can then be provided as input to and propagated through one or more rendering layers (e.g., the rendering layers 110, the renderers 214, etc.), to produce the one or more output images.

The method 1000, at block B1006, includes presenting the output images using a display device. In some implementations, the output images can be stored in one or more regions of computer memory (e.g., a database, etc.). In some implementations, the output images can be provided to another computing system (e.g., via a network or a suitable communications bus or interface).

In some implementations, the output images can be utilized to update the generative machine-learning model. For example, once the output images are generated according to the present techniques, the output images, along with images from a training dataset, can be provided as input to one or more discriminator models (e.g., the discriminator models 111, the discriminators 218, etc.). The discriminator models can be updated/trained to determine whether a given input image was produced by the generative machine-learning model or was originally included in the training dataset. A respective discriminator model may be utilized for each target domain. A loss can be calculated for the generative machine-learning model based at least on the output of the discriminators to update/train the generative machine-learning model to produce data that better resembles the training dataset. The loss may be utilized to update/train the discriminator models concurrently to better distinguish between training data samples and samples produced by the generative machine-learning model. The trainable parameters of the generative machine-learning model may be updated according to the appropriate loss(es) using a suitable optimization algorithm, such as gradient descent.

Example Content Streaming System

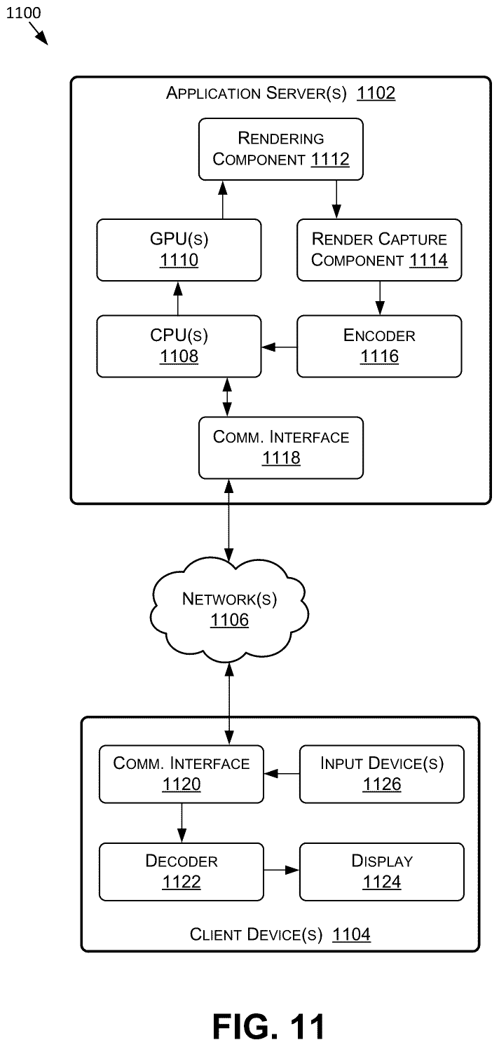

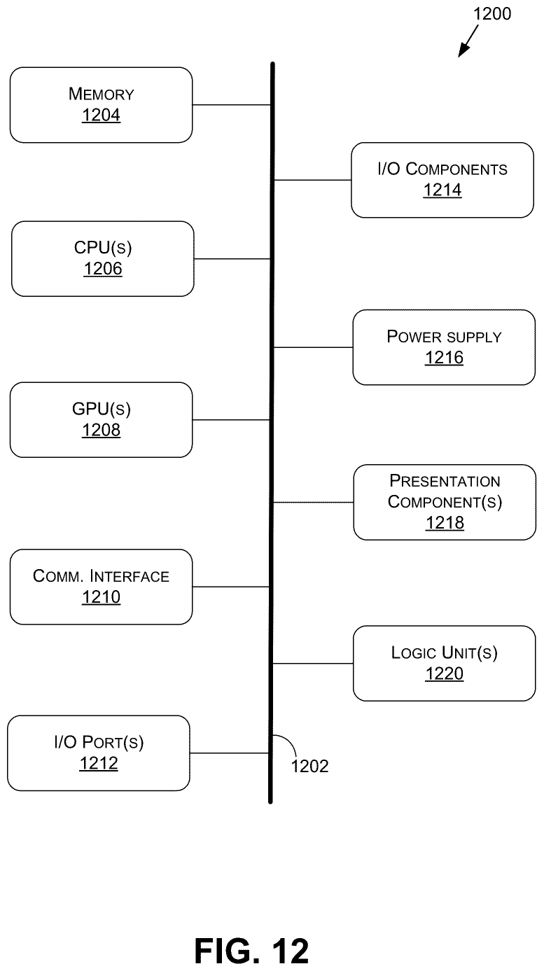

Now referring to FIG. 11, is an example system diagram for a content streaming system 1100, in accordance with some embodiments of the present disclosure. FIG. 11 includes application server(s) 1102 (which may include similar components, features, and/or functionality to the example computing device 1200 of FIG. 12), client device(s) 1104 (which may include similar components, features, and/or functionality to the example computing device 1200 of FIG. 12), and network(s) 1106 (which may be similar to the network(s) described herein). In some embodiments of the present disclosure, the system 1100 may be implemented to update and execute the various generative machine-learning models described herein. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 1100 can be implemented to receive input indicating one or more features of output to be generated using a neural network model, provide the input to the model to cause the model to generate the output, and use the output for various operations including display or simulation operations.

In the system 1100, for an application session, the client device(s) 1104 may only receive input data in response to inputs to the input device(s) 1126, transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the application server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 based at least on receiving the display data from the application server(s) 1102. The client device 1104 may receive an input to one of the input device(s) 1126 and generate input data in response. The client device 1104 may transmit the input data to the application server(s) 1102 via the communication interface 1120 and over the network(s) 1106 (e.g., the Internet), and the application server(s) 1102 may receive the input data via the communication interface 1118. The CPU(s) 1108 may receive the input data, process the input data, and transmit data to the GPU(s) 1110 that causes the GPU(s) 1110 to generate a rendering of the application session. For example, the input data may be representative of a movement of a character of the user in a game session of a game application, firing a weapon, reloading, passing a ball, turning on a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1102. In some embodiments, one or more virtual machines (VMs)—e.g., including one or more virtual components, such as vGPUs, vCPUs, etc. —may be used by the application server(s) 1102 to support the application sessions. The encoder 1116 may then encode the display data to generate encoded display data and the encoded display data may be transmitted to the client device 1104 over the network(s) 1106 via the communication interface 1118. The client device 1104 may receive the encoded display data via the communication interface 1120 and the decoder 1122 may decode the encoded display data to generate the display data. The client device 1104 may then display the display data via the display 1124.

Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may be arranged in various topologies, including but not limited to bus, star, ring, mesh, tree, or hybrid topologies. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU 1208 may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, including wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208. In some embodiments, a plurality of computing devices 1200 or components thereof, which may be similar or different to one another in various respects, can be communicatively coupled to transmit and receive data for performing various operations described herein, such as to facilitate latency reduction.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

Example Data Center

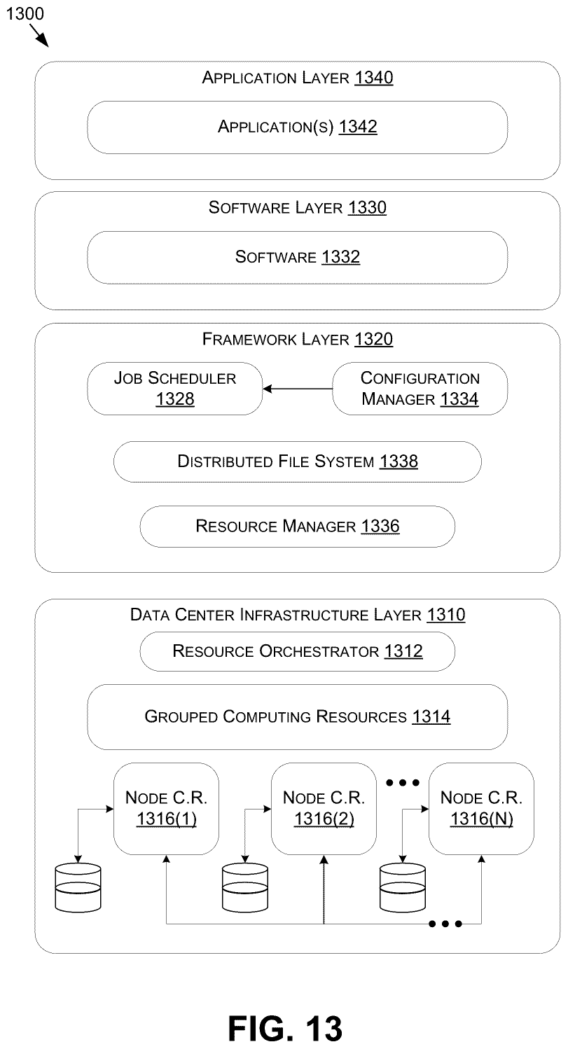

FIG. 13 illustrates an example data center 1300 that may be used in at least one embodiments of the present disclosure, such as to implement the systems 100, 200, or in one or more examples of the data center 1300. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine-learning application, including training or inferencing software, machine-learning framework software (e.g., PyTorch, TensorFlow, Caffe, etc.), and/or other machine-learning applications used in conjunction with one or more embodiments, such as to train, configure, update, and/or execute the generative machine-learning models 104 and 200.

In at least one embodiment, any of configuration manager 1334, resource manager 1336, and resource orchestrator 1312 may implement any number and type of self-modifying actions based at least on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to update/train one or more machine-learning models (e.g., train the generative machine-learning models 104 and 200, etc.) or predict or infer information using one or more machine-learning models according to one or more embodiments described herein. For example, a machine-learning model(s) may be updated/trained by calculating weight parameters according to a neural network architecture using software and/or computing resources described above with respect to the data center 1300. In at least one embodiment, trained or deployed machine-learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor, comprising:
one or more circuits to:
generate input data according to a noise function;
determine, using a generative machine-learning model and based at least on the input data, a plurality of output images each corresponding to one of a respective plurality of image domains, the generative machine-learning model to generate a plurality of morph maps each corresponding to one of the respective plurality of image domains; and
present, using a display device, the plurality of output images.

2. The processor of claim 1, wherein the one or more circuits are to update the generative machine-learning model by applying the input data to a generative neural network of the generative machine-learning model to generate a set of output features.

3. The processor of claim 2, wherein the one or more circuits are to update the generative machine-learning model by applying the plurality of morph maps to the set of output features to generate a set of morphed output features.

4. The processor of claim 1, wherein the one or more circuits are to update the generative machine-learning model based at least on a plurality of outputs of a respective plurality of discriminator models that respectively receive the plurality of output images as input, each of the respective plurality of discriminator models corresponding respectively to one of the respective plurality of image domains.

5. The processor of claim 1, wherein each of the respective plurality of image domains correspond to a geometrically different domain.

6. The processor of claim 1, wherein the plurality of morph maps each comprises a pixel-wise transformation vector.

7. The processor of claim 1, wherein the generative machine-learning model comprises a plurality of rendering layers updated to generate the plurality of output images.

8. The processor of claim 7, wherein the plurality of rendering layers receive a sum calculated based at least on a set of morphed features.

9. The processor of claim 7, wherein the plurality of rendering layers comprise at least one shared weight value.

10. The processor of claim 1, wherein the generative machine-learning model comprises a plurality of layers, at least one layer of the generative machine-learning model being a convolution layer.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

12. A processor comprising:
one or more circuits to:
determine, using a generative machine-learning model and based at least on input noise data, a plurality of output images each corresponding to one of a respective plurality of image domains, the generative machine-learning model to generate a plurality of morph maps each corresponding to one of the respective plurality of image domains; and
update the generative machine-learning model based at least on a plurality of outputs from a respective plurality of discriminator models, each of the respective plurality of discriminator models corresponding respectively to one of the respective plurality of image domains.

13. The processor of claim 12, wherein the generative machine-learning model comprises at least one of:
a pre-trained generative neural network;
a variational autoencoder (VAE); or
a generative adversarial network (GAN).

14. The processor claim 12, wherein each of the respective plurality of image domains correspond to a geometrically different domain.

15. The processor of claim 12, wherein the plurality of morph maps each comprises a pixel-wise transformation vector.

16. The processor of claim 12, wherein the plurality of morph maps are generated using at least a first layer of the generative machine learning model, and the one or more circuits are to update the generative machine-learning model by applying the plurality of morph maps to a set of features generated by at least a second layer of the generative machine-learning model.

17. The processor of claim 12, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

18. A method, comprising:
generating, using one or more processors, input data according to a noise function;
determining, using the one or more processors and a generative machine-learning model, based at least on the input data, a plurality of output images each corresponding to one of a respective plurality of image domains, the generative machine-learning model to generate a plurality of morph maps each corresponding to one of the respective plurality of image domains; and
presenting, using the one or more processors and using a display device, the plurality of output images.

19. The method of claim 18, further comprising updating, by using the one or more processors, the generative machine-learning model by applying the input data to a generative neural network of the generative machine-learning model to generate a set of output features.

20. The method of claim 19, further comprising updating, by using the one or more processors, the generative machine-learning model by applying the plurality of morph maps to the set of output features to generate a set of morphed output features.
